(19) United States
(12) Patent Application Publication
(10) Pub. No.: US 2024/0182192 A1
(43) Pub. Date: Jun. 6, 2024

(54) DRONE FOR EMERGENCY SITUATION AND METHOD FOR CONTROLLING SAME

(71) Applicant: Korea Advanced Institute of Science And Technology, Daejeon (KR)

(72) Inventors: Jung-Wuk HONG, Daejeon (KR); Youngjun CHOI, Daejeon (KR); Sangmin LEE, Daejeon (KR); Kwonhwan KO, Daejeon (KR)

(73) Assignee: Korea Advanced Institute of Science And Technology, Daejeon (KR)

(21) Appl. No.: 18/554,329

(22) PCT Filed: Apr. 7, 2022
(86) PCT No.: PCT/KR2022/005072

§ 371 Date: Oct. 6, 2023

(30) Foreign Application Priority Data
Apr. 9, 2021 (KR) 10-2021-0046368

(51) Int. Cl. B64U 10/14; A62B 3/00; B64U 101/55

(52) U.S. Cl. CPC B64U 10/14; A62B 3/005; B25D 2250/271; B64U 2101/55; B64U 2201/20

(57) ABSTRACT

In accordance with the present invention, the drone includes a frame having a plurality of arms, a plurality of rotors connected to the plurality of arms, and propellers fixed on the plurality of rotors. The drone also includes an arm hammer part disposed on at least one of the plurality of arms and a rotor hammer part disposed on at least one of the plurality of rotors. A structure capable of destroying a glass window at once is mounted on the quadcopter drone, and a number of quadcopter drones, corresponding to the number of glass windows that need to be destroyed, are coupled so that almost all glass windows of a building where a disaster has occurred can be destroyed at once. As a result, evacuation and rescue activities for people trapped inside the building can be performed efficiently and safely through glass windows, and flexible response is possible even in situations where it is difficult to destroy glass windows from the inside during a disaster.

### TECHNICAL FIELD

The present invention relates to a drone for emergency situations and control method thereof, and more specifically, it relates to a drone and control method thereof that can destroy obstacles such as glass windows at once for the purpose of rescue and evacuation.

### BACKGROUND ART

Residential buildings such as apartments and houses, as well as public transportation such as subways, buses, and ships, always have a risk of disasters such as fire and flooding. In particular, public transportation is often equipped with only a single door for entrance/exit, it makes difficult for passengers to escape quickly in case of a disaster. Thus, if the entrance does not work, the loss of life could be worse.

Generally, when an accident occurs on a bus, train, subway or ship, the glass windows are manually broken to secure additional escape routes. For this purpose, a small amount of safety equipment such as emergency hammer that can break the glass windows are provided in case of a disaster.

However, manual glass-breaking equipment is difficult to provide enough compared to the number of glass windows, and it is not easy to lead to safe evacuation because the person in an emergency situation has to use the equipment to break the glass windows themselves.

Also, when breaking windows to rescue people in a building fire, a backdraft phenomenon can occur where the combustion gas ignites instantaneously due to the sudden supply of oxygen, which can injure both rescuers and rescues. Therefore, there is a need for research and development of technology when a disaster occurs, it can remotely destroy a large amount of glass at the same time accurately where many windows of a structure are installed.

Related art references
D1: Korean Laid-Open Patent Publication No. 10-2018-0061209 (published on Dec. 9, 2019)
D2: Korean Patent Publication No. 10-0538429 (Registered on Dec. 16, 2005)

### DISCLOSURE OF THE INVENTION

### Technical Problem

The present invention has been devised in view of the above-mentioned technical requirements, and an object of the present invention is to provide a drone and a control method thereof that can destroy a plurality of windows where windows are installed, such as buildings, vehicles, trains, ships, etc., and it is urgent to escape through windows in a structure, when a disaster occurs such as fire or flooding.

### Technical Solution

According to the present invention for achieving the object, a drone comprising: a frame having a plurality of arms; a plurality of rotors connected to the plurality of arms and having propellers; an arm hammer part disposed on at least one of the plurality of arms; and a rotor hammer part disposed on at least one of the plurality of rotors among the plurality of rotors.

The arm hammer part is protruded in a direction in which the arm extends from a center of the frame. Also, the rotor hammer part is protruded in a direction of a rotation axis of the rotor.

And the rotor hammer part is disposed on an arm that does not include the arm hammer part.

Also, the frame has four arms, the arm hammer part is disposed on two adjacent arms of the four arms, and the rotor hammer part is disposed on rotors of other two arms of the four arms.

And the four arms are spaced apart by 90°

Also, the drone further comprises a controller for controlling the plurality of rotors to control the flight of the drone and colliding the arm hammer part with a target object as first collision after positioning an arm hammer in front based on the forwarding direction of the drone.

And the controller, immediately after the first collision occurs, rotates the drone to cause a second collision of the rotor hammer part to the target object.

Also, the drone further comprises an impact detection sensor for detecting an impact at an impact moment of the first collision.

Meanwhile, according to the present invention for achieving the object, a method of controlling a drone comprising a frame having a plurality of arms and a plurality of rotors, wherein the drone comprises an arm hammer parts disposed on at least one of the plurality of arms among the plurality of arms and rotor hammer parts disposed on at least one of the plurality of rotors among the plurality of rotors respectively. The method comprises steps of: rotating the arm hammer parts to face a forwarding direction of the drone; and colliding the arm hammer parts to a target object in a first collision.

Also, the method of controlling the drone, further comprises rotating the drone after the first collision to collide the rotor hammer parts to the target object as a second collision.

And, the target object is a plurality of glass windows, and the method of controlling the drone further comprises controlling a plurality of drones corresponding to each of the plurality of glass windows, colliding the drones corresponding to each of the plurality of glass windows to simultaneously destroy the plurality of glass windows.

Also, the method of controlling the drone further comprises receiving a wireless collision command signal from a user to execute the drone control.

And, the arm hammer parts protrudes in a direction wherein the arm is extended from the center of the frame.

Also, the rotor hammer parts protrude in a direction of the rotation axis of the rotors

And the rotor hammer part is disposed on an arm that does not include the arm hammer part.

Also, the frame comprises four arms, the arm hammer part is disposed on two arms adjacent each other among the four arms, the rotor hammer part is disposed on rotors disposed to other two arms among the four arms.

And the four arms are spaced apart by 90°.

### Advantageous Effects

According to the present invention, a mounted structure is capable of destroying a window at once, and a quadcopter is coupled to be destroyed as many as the number of windows, thus it can destroy most of windows of a building at once when a disaster occurs. Accordingly, evacuation and rescue through windows can be performed efficiently and safely, and flexible response is possible in situations where it is difficult to destroy windows at the inside of building when a disaster occurs.

### BRIEF DESCRIPTION OF THE DRAWINGS

FIG. 1 shows a collision mode of a drone.

FIG. 2 is a perspective view of a drone according to the present invention.

FIG. 3 is a top view of a drone according to the present invention.

FIG. 4 is a side view of a drone according to the present invention.

FIG. 5 is a flowchart showing a method for controlling a drone according to the present invention.

FIG. 6 is a schematic diagram showing a first collision process of a drone according to the present invention.

FIG. 7 is a schematic diagram showing a second collision process of a drone according to the present invention.

### MODE FOR CARRYING OUT THE INVENTION

Hereinafter, embodiments disclosed in the present specification will be described in detail with reference to the accompanying drawings, but the same or similar components will be assigned the same reference numerals regardless of the drawing symbols, and redundant descriptions thereof will be omitted.

the suffix “part” used for the components in the following description is assigned or mixed only for the convenience of writing the specification, and does not have a meaning or role that distinguishes each other by itself. Also, when describing the embodiments disclosed in the present specification, detailed descriptions of related prior art are omitted if they are deemed to obscure the gist of the embodiments disclosed in the present specification. In addition, the accompanying drawings are intended to facilitate understanding of the embodiments disclosed in the present specification, and the technical idea disclosed in the present specification is not limited by the accompanying drawings, and it should be understood that it includes all changes, equivalents or substitutes within the scope of the idea and technology of the present invention.

The present invention relates to a system of a plurality of quadcopters equipped with a special part (e.g., a special small hammer) capable of destroying a window at once, and a plurality of quadcopters can be constructed as many as the number of windows installed in a structure where a disaster occurs and are coupled to have the same movement.

In order to destroy the windows at once during evacuation and rescue operations, an external quadcopter operator appropriately manipulates the collision speed and angle of the quadcopters to collide multiple quadcopters with each window. The impact force by the quadcopter is determined by the correlation between the collision speed and angle.

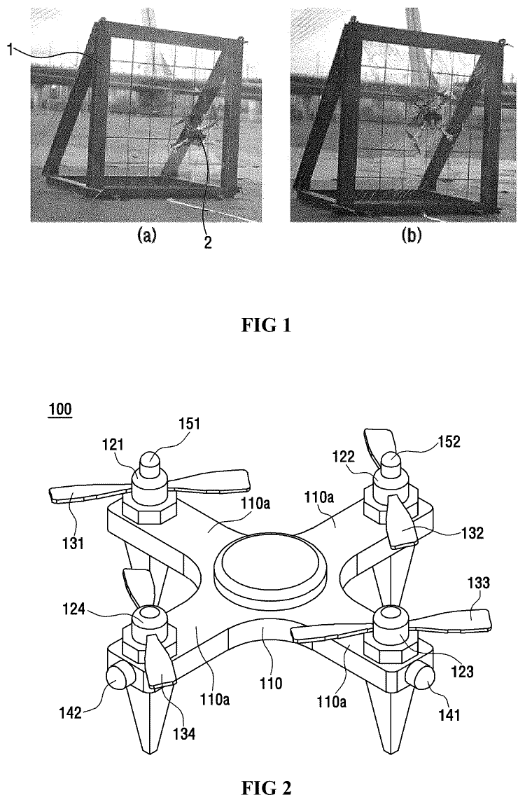

As shown in FIG. 1, the collision behavior of the quadcopter 2 and the glass plate 1 can be composed of a first collision (FIG. 1(a)) by the two front rotors and a second collision (FIG. 1(b)) by the two rear rotors. Cracks start to form in a small area of the glass window 1 where the rotor collides due to the collision of the quadcopter 2 with high collision durability, and then as the cracks rapidly progress, the glass window 1 is destroyed.

The probability of glass destruction considering complex collision conditions was derived through a collision experiment between the quadcopter 2 and the glass plate 1. The probability of glass destruction according to the specifications (mass and speed) of the quadcopter 2 and the specifications (width, height and thickness) of the glass window 1 can be calculated through a probabilistic empirical formula.

For example, a quadcopter 2 of 1 kg can damage a glass plate 1 of 8 mm thickness with a 50% probability when flying at a speed of 18.8 m/s. The destruction of the glass window 1 at a thin thickness when using a quadcopter 2 of 1 kg weight occurs in the first collision by the front rotor as shown in FIG. 1(a). However, in the case of glass plates with a thickness of 5 mm or more that are mostly used in buildings, most of the glass is not destroyed by the first collision by the front rotor, and this impact causes the front rotor to bounce off as well as cause the aircraft to flip forward. This rotational force adds force to the second collision by the rear rotor as shown in FIG. 1(b), and eventually the glass window 1 is destroyed.

The present invention is for effective destruction of glass windows by collision of quadcopters, and installs a first collision destruction part (e.g., hammer) on the front end of the front frame arm of the quadcopter and a second collision destruction part on the rear rotor to maximize the destructive force of the first collision occurring at the front end of the front frame arm and the second collision occurring at the wedge of the rear rotor.

More specifically, two destruction parts (e.g., glass window destruction hammer) are attached to each left and right of the front frame arm of the quadcopter, two destruction parts are attached to each left and right of the rear rotor to increase the possibility of breaking the glass window and effectively destroy multiple glasses with remote control.

By using a quadcopter system coupled with glass windows that can destroy multiple glass windows at once, most glass windows can be efficiently destroyed at once in a disaster situation, thereby helping evacuation and rescue work through windows. Accordingly, it is possible to minimize casualties while ensuring the safety of both rescuers and rescuers when an emergency occurs in apartments, buildings and various public transportation means such as houses, railways, buses, ships, etc. in downtown areas.

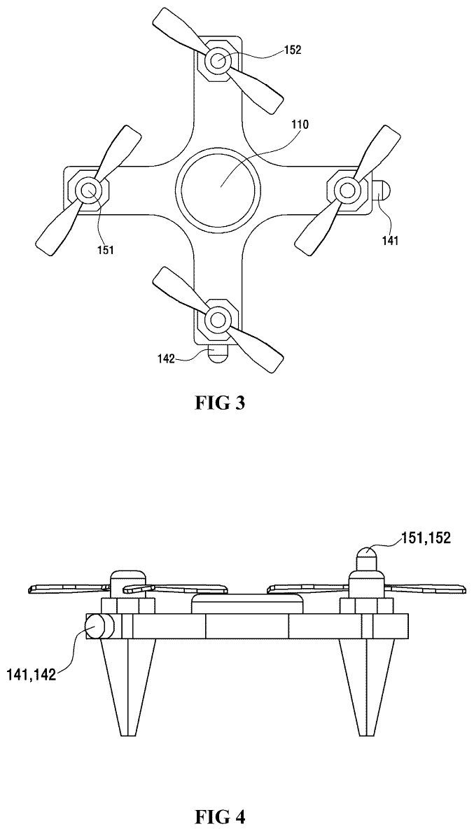

FIGS. 2 to 4 illustrate the structure of a drone according to the present invention. Specifically, FIG. 2 is a perspective view of a drone according to the present invention, FIG. 3 is a top view of a drone according to the present invention, and FIG. 4 is a side view of a drone according to the present invention.

Generally, drones are implemented as tricopters, quadcopters, hexacopters, octocopters, etc. depending on the number of propellers. For the sake of explanation, the following description is set forth based only on quadcopters, but the present invention should not be limited thereto, and in other embodiments, various embodiments such as tricopters, hexacopters, octocopters, etc. can be implemented. According to the present invention, as shown in FIGS. 2 to 4, a drone 100 includes a frame 110, rotors 121 to 124, and propellers 131 to 134.

According to the present invention, as shown in FIGS. 2 to 4, a drone 100 includes a frame 110, rotors 121 to 124, and propellers 131 to 134.

The frame 110 includes a plurality of arms 110a extending from the center. The plurality of arms 110a are members in the length direction, and it could be configured various shapes, lengths, widths, and thicknesses. In FIGS. 2 to 4a, it is configured to total of four arms 110a, however, it could be configured to fewer or more arms 110a.

The rotors 121 to 124 are connected to the plurality of arms 110a. The propellers 131 to 134 are fixed to the rotors 121 to 124. The rotation speed, rotation direction, etc. of each rotors 121 to 124 are controlled, the drone 100 takes off, flies, lands, etc. accordingly. In FIGS. 2 to 4, the rotors 121 to 124 are shown to be disposed at the end portions of the plurality of arms 110a, however, it is not limited thereto. In other words, the rotors 121 to 124 can be disposed at an appropriate position of the arm 110a in the length direction.

At least one of the plurality of arms includes an arm hammer part 141, 142. The arm hammer part 141, 142 may protrude in the direction in which the arm 110a extends from the center of the frame 110. At least one of the plurality of rotors includes a rotor hammer part 151, 152. The rotor hammer part 151, 152 may protrude in the direction of the rotation axis of the rotor 121, 122. The arm hammer part 141, 142 and the rotor hammer part 151, 152 may be made of a material suitable for glass window destruction such as metal, however, it is not limited to any specific material.

At least one of the plurality of rotors includes a rotor hammer part 151, 152. The rotor hammer part 151, 152 may protrude in the direction of the rotation axis of the rotor.

The arm hammer part 141, 142 and the rotor hammer part 151, 152 may be made of a material suitable for glass window destruction such as metal, however, it is not limited to any specific material.

More specifically, the frame 110 may include four arms 110a spaced apart from each other by 90°, and the arm hammer part 141, 142 may be disposed on two adjacent arms among the four arms 110a. In addition, the rotor hammer part 151, 152 may be disposed on the rotors 121, 122 located on the other two arms among the four arms 110a. In other words, the rotor hammer part 151, 152 may be disposed only on an arm that does not include the arm hammer part 141, 142. However, in another embodiment, the rotor hammer part 151, 152 and the arm hammer part 141, 142 could be disposed on the same arm, and all arms could include the rotor hammer part 151, 152 and the arm hammer part 141, 142.

In addition, according to the present invention, a drone may further include a controller (not shown) for controlling its takeoff and landing and flight, and a wireless communication unit (not shown) for receiving a control signal from an operator. The controller (not shown) controls the plurality of rotors 121 to 124 based on the control signal to control the flight of the drone 100.

Initially, the arm hammer part 141, 142 are positioned to the front of the drone, which is the forwarding direction of the drone 100, and then, the arm hammer part 141, 142 is collided with the target object to cause a first impact. When the arm hammer part 141, 142 is colliding with the target object, the drone 100 rotates due to inertia and centrifugal force, and the rotor hammer part 151, 152 collides with the target object to cause a second impact.

Specifically, when the drone 100 flying with a predetermined speed collides to the target object, the drone 100 rotates with a rotation axis based on the collision point (arm hammer part) between the target object and the drone 100, and then, the rotor hammer part 151, 152 strikes the target object by the rotational force to cause a second collision. The probability of destruction of the striking moment can vary depend on the mass and angular velocity of the drone 100, the strength of the rotor hammer part 151, 152, and the specifications (width, height, and thickness) of the target object.

The controller (not shown) can immediately rotate the drone, after the first collision to cause a second collision of the rotor hammer part 151, 152 with the target object to increase the destructive force.

Specifically, to increase the rotational force of the drone 100, the controller (not shown) may arbitrarily control the rear rotor to rotate the drone (100). Specifically, the controller (not shown) may immediately rotate the drone after the first collision to cause a second collision of the rotor hammer part 151, 152 to the target object. In other words, the controller (not shown) may control some or all of the rotors 121 to 124 to rotate the drone 100. In this case, because the rotational force caused by the first collision and the rotational force caused by the rotor drive are added, the destructive force of the second collision can be further improved. The drone 100 can further comprise an impact detection sensor that detects an impact moment of the first collision, and the rotation of the drone 100 for the second collision can be performed when the impact moment is detected by the impact detection sensor.

As described above, a quadcopter having four arms and rotors are optimal to increase the destructive power of the second collision by rotation due to the first collision. Because four arms 110a spaced 90° apart are symmetrical structures, collisions of two arm hammer parts 141, 142 provided on two arms maximize the rotational force of the quadcopter, thus, the impact force of two rotor hammer parts 151, 152 also can be maximized to destroy the target object (window glass) efficiently.

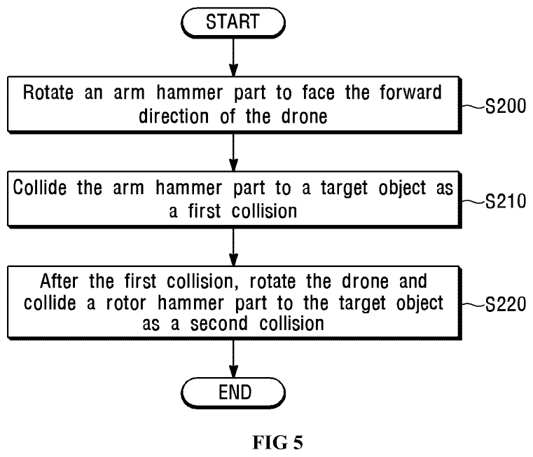

FIG. 5 is a flowchart illustrating a drone control method according to the present invention. The drone used in the drone control method according to the present invention includes a frame 110, rotors 121 to 124, and propellers 131 to 134 as described above. The frame 110 includes a plurality of arms 110a extending from the center. The plurality of arms 110a may be members in the length direction, but may have various shapes, shapes, lengths, widths, and thicknesses. The rotors 121 to 124 are fixed with propellers 131 to 134 and the rotors 121 to 124 are connected to the plurality of arms 110a. The rotation speed, rotation direction, etc. of each rotors 121 to 124 can be controlled so that the drone 100 takes off, flies, lands, etc. Since the other structures are as described above, detailed description thereof will be omitted here.

In the drone control method according to the present invention, the arm hammer part is rotated to face the forwarding direction of the drone S200. Thereafter, the arm hammer part is collided with the target object S210.

By the first collision step, when the arm hammer part collides with the target object, the drone rotates by inertia and centrifugal force, and the rotor hammer part collides with the target object, thereby causing a second impact. At this time, in order to increase the rotational force, it can further include a step S220 of rotating the drone and colliding the rotor hammer part with the target object for a second time after the first collision. In order to detect the timing of the second collision point, it can include a step of monitoring and detecting an impact caused by the first collision.

The target object can be a plurality of glass windows, and a plurality of drones can be coupled to each of the plurality of glass windows. That is, by controlling the drone corresponding to each glass window, after approaching to the coupled glass window, performing the first collision and the second collision described above, it becomes possible to destroy a plurality of glass windows at the same time. At this time, it is possible to further include a step of receiving a wireless collision command signal from an operator, and the drone control method described above may be triggered by the wireless collision command signal.

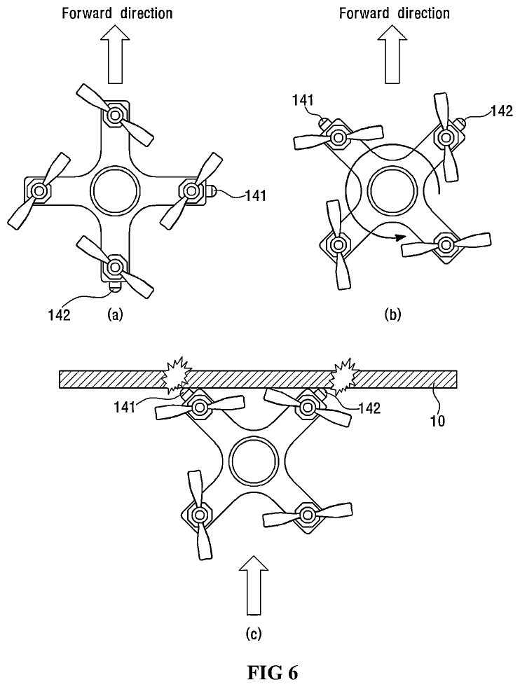

FIG. 6 is a schematic diagram illustrating a first collision process of a drone according to the present invention. First, as shown in (a) of FIG. 6, the drone 100 fly forward toward a target object such as a glass window. At this time, if the arm hammer part 141, 142 is not located in front based on the forwarding direction, as shown in (b) of FIG. 6, the rotor is controlled to rotate the drone 100 and fix the position of the arm hammer part 141, 142 to the front.

Thereafter, it approaches toward the target object at a speed that can maximize the probability of destruction by the first collision, and collides the arm hammer part 141, 142 with the target object as shown in (c) of FIG. 6. The speed can vary depending on the mass and velocity of the drone 100, the strength of the arm hammer part 141, 142, and the specifications (width, height, and thickness) of the target object 10.

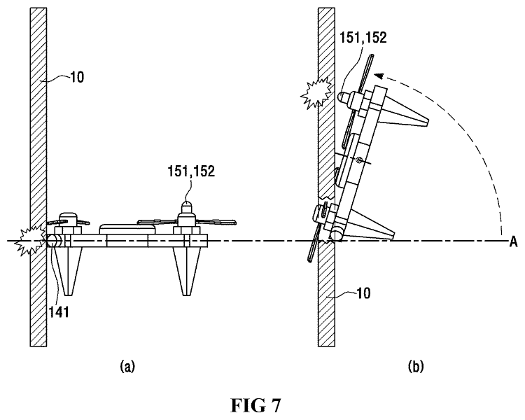

FIG. 7 is a schematic diagram illustrating a second collision process of a drone according to the present invention. As shown in (a) of FIG. 7, the target object may be completely destroyed by the first collision by the arm hammer part 141, 142, but if not, complete destruction is achieved by the second collision.

Specifically, when the drone 100 flying at a predetermined speed collides with the target object 10 as shown in (a) of FIG. 7, the drone 100 rotates with the collision point (arm hammer part) between the target object 10 and the drone 100 as a rotation axis in A of FIG. 7, and the second collision occurs by the rotor hammer part 151, 152 striking the target object by the rotational force. The probability of destruction at this time can vary depending on the mass and angular velocity of the drone 100, the strength of the rotor hammer part 151, 152, and the specifications (width, height, and thickness) of the target object 10.

On the other hand, to increase the rotational force of the drone 100, the controller (not shown) may arbitrarily control the rear rotor to rotate the drone 100. Specifically, the controller (not shown) may rotate the drone immediately after the first collision and cause the second collision of the rotor hammer part 151, 152 to the target object. In this case, since the rotational force caused by the first collision and the rotational force caused by the rotor driving are added, the destructive force of the second collision can be further improved. The drone 100 may further include an impact detection sensor (not shown) for detecting an impact at the time of the first collision, and at the moment when an impact is detected by the impact detection sensor (not shown), the controller (not shown) may control some or all of the rotors 121 to 124 to rotate the drone 100.

The first and second collision processes described above can be applied to drone group flight. That is, a plurality of drones coupled to a plurality of glass windows approach to the position coordinates of each glass window as a target and cause the first and second collisions, thereby destroying the glass windows at once. This can be very useful in emergency situations that occur in buildings or trains where glass windows are arranged at regular intervals.

Meanwhile, the quadcopter control method described above can be implemented in the form of program instructions that can be performed through various computer means and recorded on a computer-readable medium. The computer-readable recording medium may include program instructions, data files, data structures, etc., alone or in combination. The program instructions recorded on the medium may be specially designed and configured for the present invention, or may be available to those skilled in the computer software art. Examples of the computer-readable recording medium include magnetic media such as hard disks, floppy disks, and magnetic tapes, optical media such as CD-ROMs and DVDs, magneto-optical media such as floptical disks, and ROMs, RAMs, flash memories, etc. It includes hardware devices that are specially configured to store and execute program instructions. Examples of program instructions include not only machine language code generated by a compiler, but also high-level language code that can be executed by a computer using an interpreter or the like. The hardware devices mentioned above may be configured to operate as one or more software modules for performing the operations of the present invention, and vice versa.

The features, structures, effects, etc. described in the embodiments above are included in one embodiment of the present invention and are not necessarily limited to only one embodiment. Furthermore, the features, structures, effects, etc. exemplified in each embodiment can be combined or modified by those skilled in the art to which the embodiments belong for other embodiments. Therefore, such combinations and modifications should be interpreted as being within the scope of the present invention.

1. A drone comprising:
a frame having a plurality of arms;
a plurality of rotors connected to the plurality of arms and having propellers;
an arm hammer part disposed on at least one of the plurality of arms, and
a rotor hammer part disposed on at least one of the plurality of rotors.

2. The drone of claim 1,
wherein the arm hammer part is protruded in a direction in which the arm extends from a center of the frame.

3. The drone of claim 2,
wherein the rotor hammer part is protruded in a direction of a rotation axis of the rotor.

4. The drone of claim 1,
wherein the rotor hammer part is disposed on an arm that does not include the arm hammer part.

5. The drone of claim 1,
wherein the frame has four arms,
wherein the arm hammer part is disposed on two adjacent arms of the four arms, and
wherein the rotor hammer part is disposed on rotors of other two arms of the four arms.

6. The drone of claim 5,
wherein the four arms are spaced apart by 90°.

7. The drone of claim 1,
further comprising a controller for controlling the plurality of rotors to control the flight of the drone and colliding the arm hammer part with a target object as first collision after positioning an arm hammer in front based on the forwarding direction of the drone.

8. The drone of claim 1,
wherein the controller, immediately after the first collision occurs, rotates the drone to cause a second collision of the rotor hammer part to the target object.

9. The drone of claim 7,
further comprising an impact detection sensor for detecting an impact at an impact moment of the first collision.

10. The drone of claim 7,
further comprising a communication unit that receives wireless control signal from a user,
wherein the controller controls the rotation of the rotors to perform a first collision and a second collision of the drone when receiving a wireless collision command signal by the communication unit.

11. A method of controlling a drone comprising a frame having a plurality of arms and a plurality of rotors, wherein the drone comprises an arm hammer parts disposed on at least one of the plurality of arms among the plurality of arms and rotor hammer parts disposed on at least one of the plurality of rotors among the plurality of rotors respectively, the method comprising steps of:
rotating the arm hammer parts to face a forwarding direction of the drone; and
colliding the arm hammer parts to a target object in a first collision.

12. The method of claim 11,
further comprises a step of:
rotating the drone after the first collision to collide the rotor hammer parts to the target object as a second collision.

13. The method of claim 11, wherein the target object is a plurality of glass windows, further comprises a step of:
controlling a plurality of drones corresponding to each of the plurality of glass windows, colliding the drones corresponding to each of the plurality of glass windows to simultaneously destroy the plurality of glass windows.

14. The method of claim 11, further comprises a step of receiving a wireless collision command signal from a user to execute the drone control.

15. The method of claim 11, wherein the arm hammer parts protrudes in a direction wherein the arm is extended from the center of the frame.

16. The method of claim 11, wherein the rotor hammer parts protrude in a direction of the rotation axis of the rotors.

17. The method of claim 11, wherein the rotor hammer part is disposed on an arm that does not include the arm hammer part.

18. The method of claim 11, wherein the frame comprises four arms, the arm hammer part is disposed on two arms adjacent each other among the four arms, the rotor hammer part is disposed on rotors disposed to other two arms among the four arms.

19. The method of claim 18, wherein the four arms are spaced apart by 90°.
